(19) United States
(12) Patent Application Publication
(10) Pub. No.: US 2008/0223196 A1
(43) Pub. Date: Sep. 18, 2008

(54) Semiconductor Device Having Music Generation Function, and Mobile Electronic Device, Mobile Telephone Device, Spectacle Instrument, and Spectacle instrument Set Using the Same

(76) Inventors: Shunsuke Nakamura, Fukuoka (JP); Masamichi Ishihara, Fukuoka (JP)

Correspondence Address: WENDEROTH, LIND & PONACK, L.L.P., 2033 K STREET N. W., SUITE 800, WASHINGTON, DC, 20006-1021, US

(21) Appl. No.: 10/586,443

(22) PCT Filed: Apr. 14, 2005
(86) PCT No.: PCT/JP2005/007252

§ 371 Date: Jul. 18, 2006

(30) Foreign Application Priority Data
Apr. 30, 2004 (JP) 2004-136333

(51) Int. Cl. G10H 1/00

(52) U.S. Cl. 84/600

(57) ABSTRACT

There is provided a semiconductor device having a music generation function for automatically generating music data from image data inputted without preparing music information in advance, and a mobile electronic device, a mobile telephone device, a spectacle instrument, and a spectacle instrument set using the same. The device includes a miniature camera 11 for continuously imaging an object and inputting image data for each frame; movement section identification means 21 for identifying the portion where an object has moved within each frame from the image data inputted by the miniature camera 11; music generation means 22 for generating music data corresponding to the position identified by the movement section identification means 21; and music output means 23 for outputting music data generated by the music generation means 22. When the object moves in front of the miniature camera 11, a music in accordance with the movement of the object is automatically generated and played with sounds of various kinds of musical instruments.

### TECHNICAL FIELD

The present invention relates to a semiconductor device having a music generation function for automatically generating music data corresponding to image data, as well as a mobile electronic device, a mobile telephone device, a spectacle instrument, and a spectacle instrument set using the same.

### BACKGROUND ART

As a technology for controlling a music performance in response to an image,

Patent Document 1 discloses, for example, a technique for controlling a tempo or the like utilizing an outline of an object. In this technique, each color signal of R (red), G (green) and B (blue) is separated from an inputted video signal, and tone data which represent tones are produced as digital data in each color. Then, an object is identified on the basis of the tone data in each color and predetermined threshold data, and an outline of the object is detected, thereby controlling a performance in accordance with a degree of complexity of the detected outline.

However, with this technique disclosed in Patent Document 1, it is necessary to identify an object and to detect an outline thereof, which causes problematically large load required for processing. As another technique to solve this problem, Patent Document 2 discloses, for example, a technique in which a plurality of motion vectors are extracted from a provided image, one control vector is calculated from the extracted plurality of vectors, and a music performance is controlled based on the calculated control vector.

### Patent Document 1: Publication of Japanese Patent No. 2629740

### Patent Document 2: Unexamined Japanese Patent Publication No. 2000-276139

### DISCLOSURE OF THE INVENTION

### Problems to be Solved by the Invention

In both of the above techniques disclosed in Patent Documents 1 and 2, when reproducing music from music information or the like showing the content of a performance which has been separately provided, the music is arranged by controlling the music depending on a video image. This means that these techniques do not create music from a state with no music information provided. Therefore, in order to utilize the techniques, both music information and a video image have to be prepared in advance, respectively.

An object of the present invention is to provide a semiconductor device having a music generation function for automatically generating music data, without preparing music information or the like in advance, from inputted image data, as well as a mobile electronic device, a mobile telephone device, a spectacle instrument, and a spectacle instrument set using the same.

### Means for Solving the Problems

The semiconductor device having a music generation function of the present invention comprises movement section identification means for identifying, from image data of an object continuously imaged and inputted as image data for each frame, each position where the object has moved within the frame, and music generation means for generating music data corresponding to the position identified by the movement section identification means.

According to the semiconductor device having a music generation function of the present invention, based on image data of an object continuously imaged and inputted for each frame, the movement section identification means identifies each position where the object has moved within the frame. Then, the music generation means generates music data corresponding to the position identified within the frame, that is, the position where the object moves.

Preferably, the movement section identification means may identify the position by comparing the image data in a plurality of the frames. In comparing the image data in the plurality of frames, difference in image data between the plurality of frames means a movement of the object in the plurality of frames. Thus, the position where the image data are different can be readily identified as the section where the object has moved.

Preferably, the music generation means may generate music data from a sound source of a musical instrument which corresponds to the position identified by the movement section identification means. In this manner, music data generated from a different sound source for each music instrument corresponding to the position where the object moves can be obtained.

Preferably, the music generation means may generate music data by a scale which corresponds to the position identified by the movement section identification means. In this manner, music data generated by a different scale corresponding to the position where the object moves can be obtained.

Preferably, the music generation means may generate music data of a volume balance which corresponds to the position identified by the movement section identification means. In this manner, music data with an adjusted volume balance corresponding to the position where the object moves can be obtained.

By using the above-described semiconductor device having a music generation function of the present invention, the following mobile electronic device, mobile telephone device, spectacle instrument, and spectacle instrument set can be obtained. Specifically, a mobile electronic device of the present invention may have a structure provided with the above-mentioned semiconductor device having a music generation function of the present invention and imaging means for inputting image data. According to this mobile electronic device, music data corresponding to a position where an imaged object moves is generated from image data inputted by the imaging means. Here, if the mobile electronic device has means for outputting the music data generated by the music generation means, the music data can be directly outputted from the mobile electronic device.

Preferably, the mobile electronic device of the present invention may be provided with image processing means for processing the image data inputted by the imaging means corresponding to the position identified by the movement section identification means, and display means for displaying the image data processed by the image processing means. For example, the image processing means can change a color scheme of the image data corresponding to the position identified by the movement section identification means.

Accordingly, in addition to the music data generated corresponding to the position where the object moves, the image of the object is not displayed on the display means as it is but displayed in arranged forms with various color schemes depending on the position where the object moves, for example.

The mobile telephone device of the present invention may have a structure provided with the above-described semiconductor device having a music generation function of the present invention, imaging means for inputting image data, and means for outputting the music data generated by the music generation means. According to this mobile telephone device, music data which correspond to the position where an imaged object moves is generated from image data inputted by the imaging means, and outputted.

The spectacle instrument of the present invention may have a structure provided with the above-described semiconductor device having a music generation function of the present invention, imaging means for inputting image data, and means for outputting the music data generated by the music generation means. According to this spectacle instrument, music data which correspond to the position where an imaged object moves is generated from image data inputted by the imaging means, and outputted.

The spectacle instrument set of the present invention may have a structure provided with the above-described semiconductor device having a music generation function of the present invention, a music output device for outputting the music data generated by the music generation means, and a spectacle instrument having imaging means for inputting image data and means for transmitting the image data inputted by the imaging means to the semiconductor device. According to this spectacle instrument set, the image data inputted by the imaging means of the spectacle instrument is transmitted to the semiconductor device, and music data which correspond to the position where an imaged object moves is generated by the semiconductor device, and outputted.

### ADVANTAGES OF THE INVENTION

(1) The semiconductor device having a music generation function comprises movement section identification means for identifying, from image data of an object continuously imaged and inputted as image data for each frame, each position where the object has moved within the frame, and music generation means for generating music data corresponding to the position identified by the movement section identification means. With this device, it is not necessary to prepare music information or the like in advance as it was in conventional devices, and a compact music generation device capable of automatically producing music data corresponding to the object from the movement of the object can be obtained. Accordingly, sound can be outputted from a speaker, a sound source, or the like based on the generated music data, and music automatically generated solely from the movement of an object can be enjoyed.

(2) The mobile electronic device comprises a semiconductor device having a music generation function which identifies, from image data of an object continuously imaged and inputted as image data for each frame, each position where the object has moved within the frame and generates music data corresponding to the position identified, and an imaging device for inputting the image data. By carrying this mobile electronic device and imaging an object with the imaging device, music data corresponding to the movement of the object can be automatically generated at any place. Furthermore, provided with means for outputting music data generated by music generation means in the mobile electronic device, the music data can be directly outputted from the mobile electronic device and enjoyed.

(3) In addition, with the structure to display image data that is inputted for each frame and processed corresponding to the identified position, an image which has been arranged corresponding to the movement of an object is outputted. Thus, generated music can be enjoyed as an image as well.

(4) The mobile telephone device comprises a semiconductor device having a music generation function which identifies, from image data of an object continuously imaged and inputted as image data for each frame, each position where the object has moved within the frame and generates music data corresponding to the position identified, imaging means for inputting the image data, and means for outputting music generated by music generation means. By carrying the mobile telephone device and imaging an object with an imaging device, music data corresponding to the movement of the object can be automatically generated, outputted and enjoyed any place.

(5) The spectacle instrument comprises a semiconductor device having a music generation function which identifies, from image data of an object continuously imaged and inputted as image data for each frame, each position where the object has moved within the frame and generates music data corresponding to the position identified, imaging means for inputting the image data, and means for outputting music generated by music generation means. By wearing the spectacle instrument and imaging an object with an imaging device, music data corresponding to the movement of the object can be automatically generated, outputted and enjoyed at any place.

(6) The spectacle instrument set comprises a semiconductor device having a music generation function which identifies, from image data of an object continuously imaged and inputted as image data for each frame, each position where the object has moved within the frame and generates music data corresponding to the position identified, a music output device for outputting music data generated by music generation means, and a spectacle instrument having imaging means for inputting image data and means for transmitting the image data inputted by the imaging means to the semiconductor device. By wearing the spectacle instrument set and imaging an object with an imaging device, music data corresponding to the movement of the object can be automatically generated, outputted and enjoyed at any place.

### BRIEF DESCRIPTION OF THE DRAWINGS

FIG. 1 is a perspective view of a mobile electronic device having a music generation function according to a first embodiment of the present invention.

FIG. 2 is a block diagram showing a structure of the mobile electronic device in FIG. 1.

FIG. 3 is a drawing illustrating an example of a frame divided in a horizontal direction.

FIG. 4 is a drawing illustrating an example of a frame divided in a vertical direction.

FIG. 5 is a drawing explaining movement determination.

FIG. 6 is a drawing illustrating an example of scale setting based on the musical theory.

FIG. 7 is a drawing illustrating an example of volume balance setting.

FIG. 8 is a drawing illustrating a mobile electronic device 1 of the present embodiment in use.

FIG. 9 is a flow chart showing a music generation process of the present embodiment.

FIG. 10 is a drawing illustrating a mobile telephone device having a music generation function according to a second embodiment of the present invention.

FIG. 11 is a drawing illustrating a spectacle instrument having a music generation function according to a third embodiment of the present invention.

FIG. 12 is a drawing illustrating the spectacle instrument in FIG. 11 when being worn.

FIG. 13 is a drawing illustrating a spectacle instrument set having a music generation function according to a fourth embodiment of the present invention.

### EXPLANATION OF REFERENCE NUMERALS

1: mobile electronic device
2: mobile music player
3, 52, 6c: earphone
4: mobile telephone device
5: spectacle instrument
6a: spectacle instrument body
6b: control box
10, 40: equipment body
50, 60: frame
11, 41, 51, 61: miniature camera
12: semiconductor device
13, 42: display device
21: movement section identification means
22: music generation means
23: music output means
24: image processing means
25: display means

### BEST MODE FOR CARRYING OUT THE INVENTION

### Embodiment 1

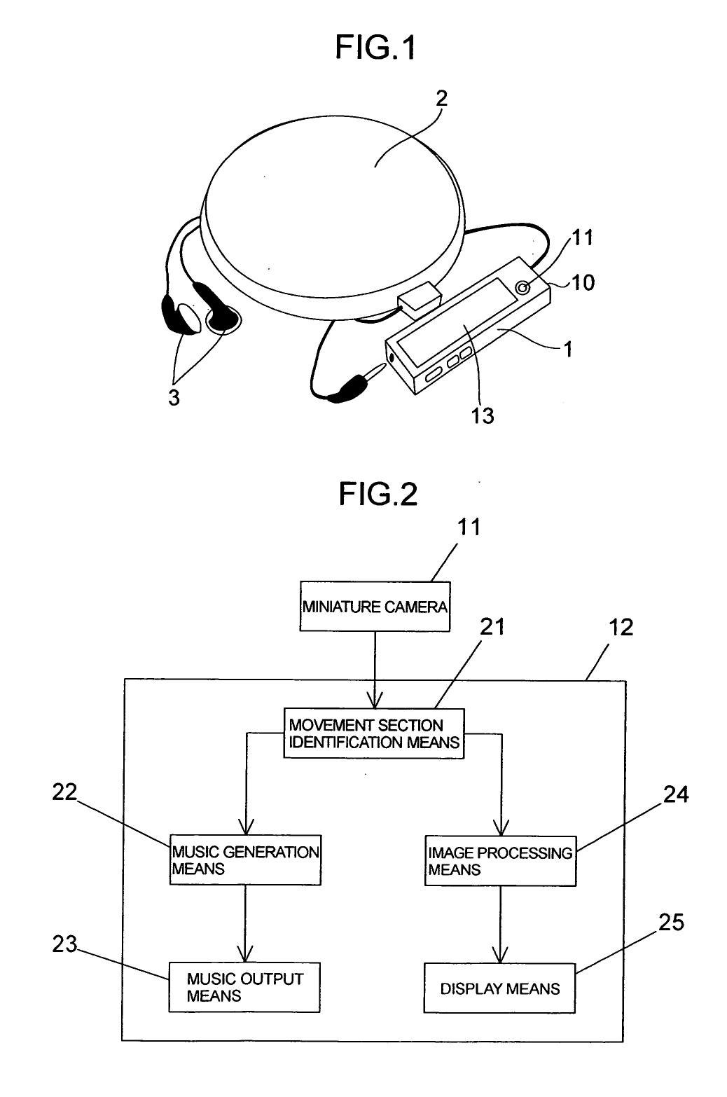

FIG. 1 is a perspective view of a mobile electronic device having a music generation function according to a first embodiment of the present invention; and FIG. 2 is a block diagram a structure of the mobile electronic device in FIG. 1.

A mobile electronic device 1 having a music generation function in the first embodiment of the present invention is, as shown in FIG. 1, connected between a mobile music player 2 such as a CD (compact disc) player, a MD (mini disc) player, or a music file player and an earphone 3 as a music output device. The mobile electronic device 1 is provided with a miniature camera 11 for imaging an object, a semiconductor device 12 having a music generation function (See FIG. 2) inside an equipment body 10 of the mobile electronic device 1, and a display device 13. The miniature camera 11 continuously images an object, for example, in eight frames per second, and inputs image data for each frame to the semiconductor device 12.

As shown in FIG. 2, the semiconductor device 12 is provided with a movement section identification means 21 for identifying the section where the object has moved within each of the frames from the image data inputted by the miniature camera 11, a music generation means 22 for generating music data corresponding to the section within the frames identified by the movement section identification means 21, a music output means 23 for outputting music data generated by the music generation means 22, an image processing means 24 for conducting image processing of the image data inputted by the miniature camera 11, and a display means 25 for displaying the image data processed by the image processing means 24 on the display device 13.

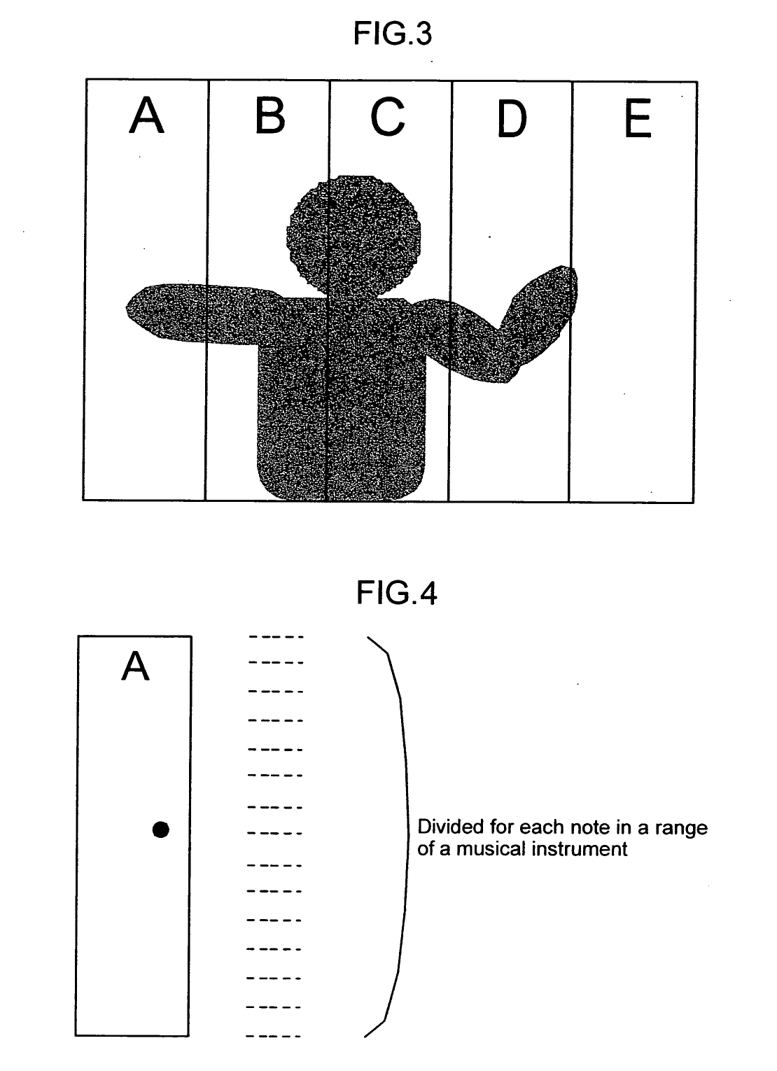

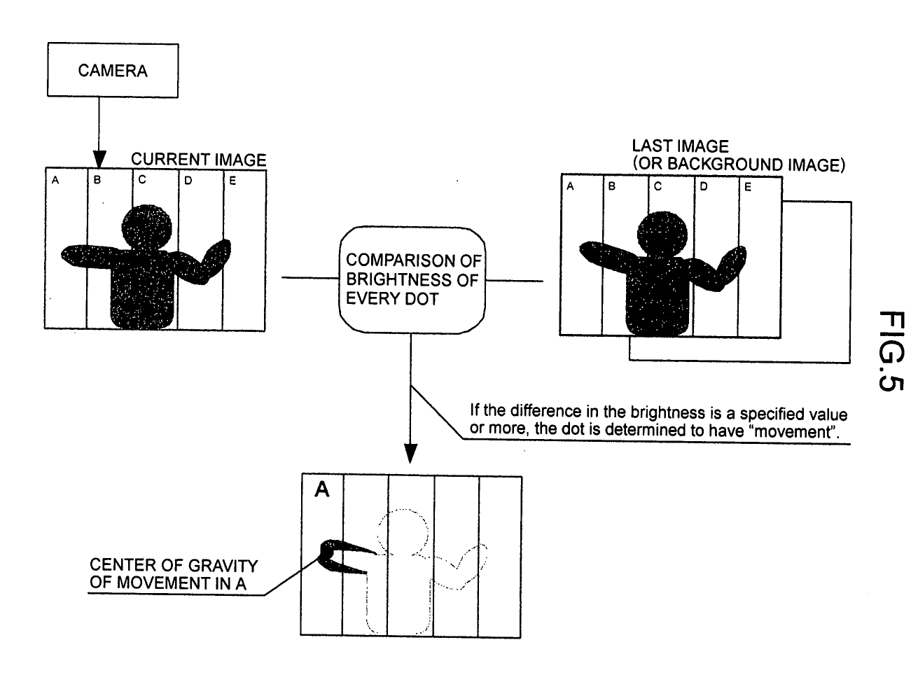

The movement section identification means 21 identifies each position where the object has moved within the frames from the image data inputted by the miniature camera 11. For example, the movement section identification means 21 identifies the position where the object has moved as a position of a section in the frame which has been divided into sections in advance. FIGS. 3 and 4 illustrate examples of the frames divided into sections. FIG. 3 is an example of a frame divided in a horizontal direction, providing horizontally divided five sections A, B, C, D and E. FIG. 4 is an example of a frame in which the section A is divided in a vertical direction for each musical note in a range of a musical instrument allocated to the section A. Similarly, the sections B to E are also divided in a vertical direction for each note in a range of each musical instrument allocated to the sections B to E, respectively.

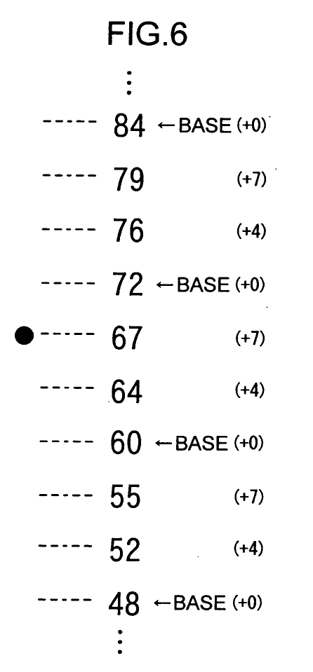

The movement section identification means 21 identifies the position of the section in horizontal and vertical directions within the frame by comparing image data between the plurality of frames. FIG. 5 explains movement determination with the movement section identification means 21. As shown in FIG. 5, based on image data inputted by the miniature camera 11, the movement section identification means 21 compares brightness of every pixel of an image in the current frame and an image in the last frame (or an image in the background). If the difference in the brightness is a specified value or more, the pixel is determined to have movement. Here, the movement section identification means 21 determines to which section in horizontal and vertical directions a center of gravity (X and Y coordinates) of a group of the pixels with movement belongs. As to the division of the frames by the movement section identification means 21, it is also possible to design the dividing direction by replacing the horizontal division with the vertical division and vice versa. Moreover, it is possible to combine horizontal and vertical divisions or to divide in a diagonal direction, a radial direction or a circumferential direction.

The music generation means 22 generates music data (data according to the standard of MIDI (Musical Instrument Digital Interface), for example) corresponding to the position of the section in horizontal and vertical directions within the frame identified with the movement section identification means 21. As shown in FIG. 3, where the frame is divided into five sections in a horizontal direction, the music generation means 22 generates music data with a sound source of a musical instrument allocated to the section in the sections A to E where the object has moved (A: piano, B: guitar, C: base, D: drum, and E: musical box, for example).

The music generation means 22 also generates music data with a musical note in a scale corresponding to the section in a vertical direction in each of the sections A to E where the object has moved. In this case, the music generation means 22 sets a standard chord and selects only a note on the standard cord based on the musical theory. For example, when the chord is “C”, as shown in FIG. 6, the standard chord (base) is multiples of 12, and notes (note numbers) are the values obtained by adding 0, 4 and 7 thereto. The timing of generating sound is set depending on each instrument; for example, the sound is generated every time, once in twice, twice with four intervals, or the like. As for a percussion instrument, due to its uniqueness, the note numbers are not notes in scales but kinds of percussion instruments to be played. Namely, variation of movement in a vertical direction means variation of kinds of percussion instruments.

The standard chord is varied with a passage of time or a certain movement as a trigger. Such variations in the standard chords (chord progression) makes the sound beautifully played as music. The variations can be made by a method of designating an order or timing in advance, a method of progressing at random, or the like. Timing of varying a chord can be a change with a passage of time as well as a change in response to movement of an object such as a change depending on an amount of movement of an object.

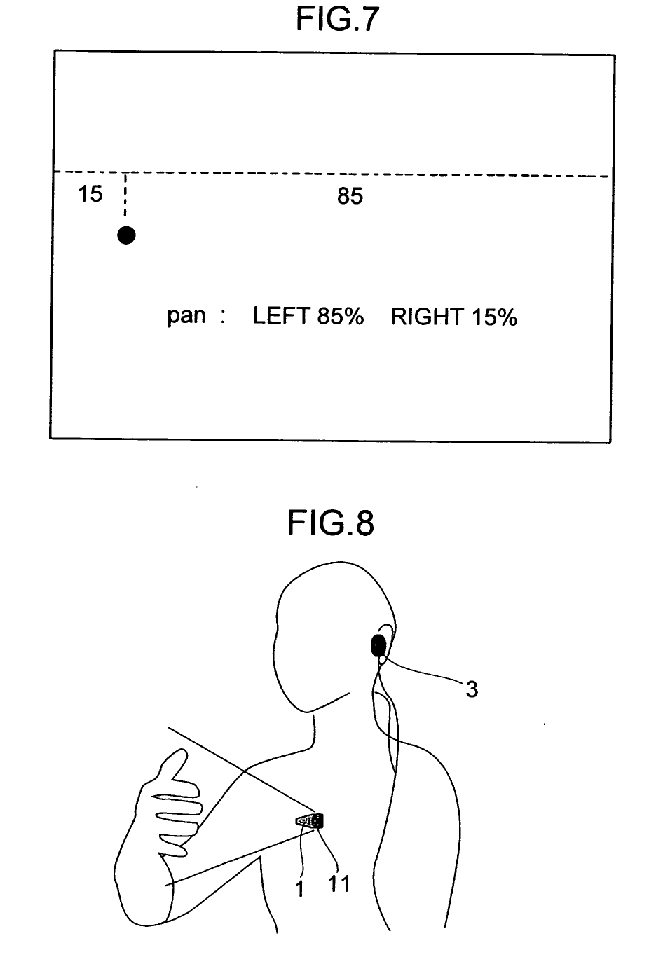

Furthermore, the music generation means 22 generates music data by a volume balance corresponding to a position of a section within a frame. FIG. 7 illustrates an example of volume balance setting. As shown in FIG. 7, the music generation means 22 generates music data so as to output a sound from both sides of the earphone 3 with a volume balance corresponding to a position in a horizontal direction in a frame identified by the movement section identification means 21.

Reverting to FIG. 2, the music output means 23 converts music data generated by the music generation means 22 into signals played as a sound through the earphone 3 and outputs the signals to the earphone 3. The music output means 23 can output a sound to a speaker such as the earphone 3 or output sound data for outputting a sound to an externally connected sound source (an external MIDI sound source, for example). It is also possible to output music data to other external equipments.

The image processing means 24 conducts image processing of image data inputted by the miniature camera 11 by varying a color scheme corresponding to a position of movement of an object identified by the movement section identification means 21. For example, it is possible to have a structure to colorize only the section having movement of an object, to lay another color on the section having movement, or to vary colors to be used and orders of colorization.

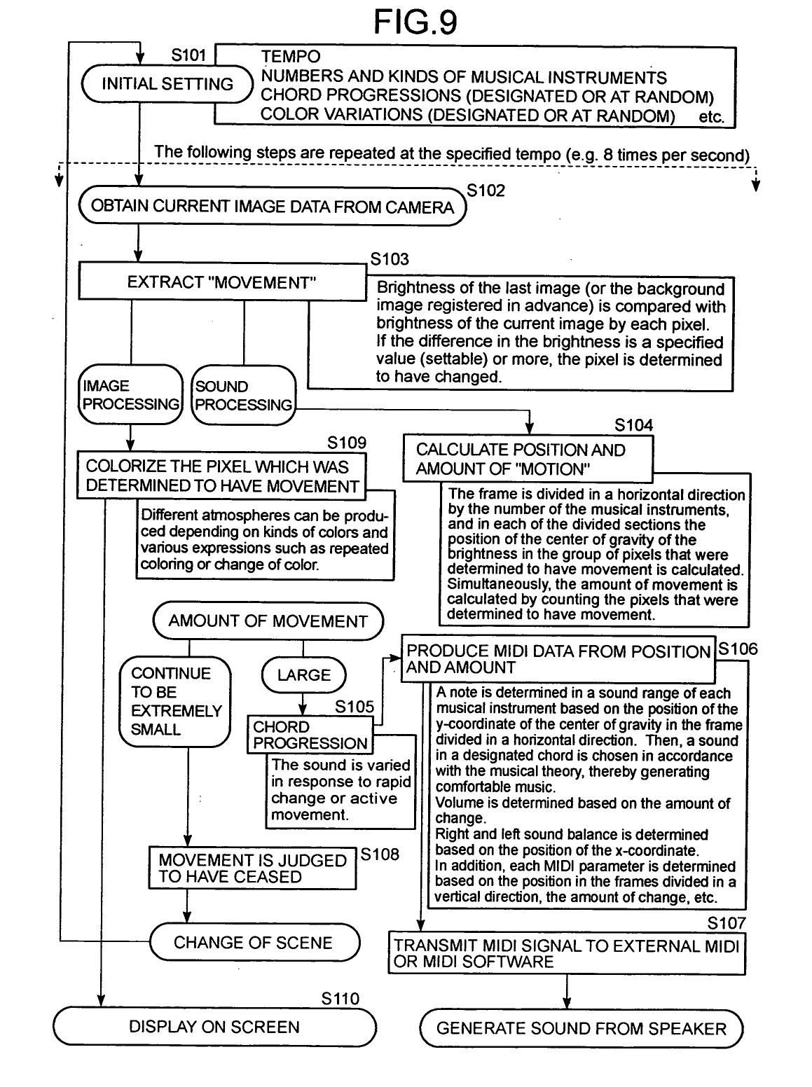

FIG. 8 is a drawing illustrating the mobile electronic device 1 of the present embodiment in use. As shown in FIG. 8, the mobile electronic device 1 of the present embodiment is fixed on a chest portion of clothes with the miniature camera 11 directing forward. The earphone 3 is put on both ears. In FIG. 8, the mobile music player 2 is not shown. Steps for generating music with the mobile electronic device 1 having the above structure will be explained below with reference to a flowchart of FIG. 9.

(S101) As initial setting, tempos of music to be generated, the numbers and kinds of musical instruments, chord progressions, color variations, or the like are set.

(S102) In front of the miniature camera 11, a user moves his/her both hands as objects, or a person facing a user as an object moves his/her body. From the miniature camera 11 that has imaged this action, current image data are inputted to the semiconductor device 12.

(S103) The movement section identification means 21 extracts movement (or identifies the position where the object has moved).

(S104) In sound processing, the music generation means 22 calculates the position of movement of the object and an amount of variation.

(S105) If the amount of variation in movement of the object is large, a variation is added to chord progression. If the amount of movement continues to be extremely small, the movement is judged to have ceased (S108), and the step returns to (S101).

(S106) The music generation means 22 generates music data (the data according to the MIDI standard) from the position of movement of the object and the amount of variation. Then, the music generation means 22 determines a volume of music data corresponding to the amount of variation of the object.

(S107) The data according to the MIDI standard thus generated is transmitted to the music output means 23 and outputted from the earphone 3.

(S109) In image processing, in the image data inputted from the miniature camera 11, the pixel where the object has moved is colorized with a specified color by the image processing means 24.

(S110) The image data processed by the image processing means 24 is displayed on the display device 13 with the display means 25.

The steps from (S102) to (S110) are repeated, for example, in eight times per second at a tempo set in the initial setting. It is also possible to have a structure that varies the tempo in response to the movement of the object in the course of the above processing.

As described above, according to the mobile electronic device 1 of the present embodiment, music data is automatically generated from the image data inputted by the miniature camera 11 which is connected to the semiconductor device 12 and outputted by the earphone 3. In other words, without preparing music information in advance as in conventional devices, movement of an object acting in front of the miniature camera 11 connected to the semiconductor device 12 automatically generates music corresponding to the movement of the object, which is played with sounds of various musical instruments.

By carrying the mobile electronic device 1, which is compact, with the mobile music player 2 and imaging an object with the miniature camera 11, music data corresponding to movement of the object can be automatically generated at any place. Moreover, since the mobile electronic device 1 is provided with the earphone 3 for outputting the music data generated by the music generation means 22 as a sound, the generated music data can be directly outputted through the earphone 3 and enjoyed.

According to the mobile electronic device 1 of the present embodiment, while music is being played, image data inputted by the miniature camera 11 is arranged corresponding to movement of an object and displayed on the display device 13. Therefore, with the mobile electronic device 1 of the present embodiment, generated music can be enjoyed not only by hearing but also by sight. Such a combination of a sound and an image can be utilized in various fields.

In the present embodiment, a structure with the miniature camera 11 housed in the mobile electronic device 1 has been explained. However, it can be designed with the miniature camera 11 which is externally connected as a separate body. Furthermore, it is possible to connect the plurality of miniature cameras 11 to simultaneously input the plurality of image data, thereby playing a variety of sounds all together.

### Embodiment 2

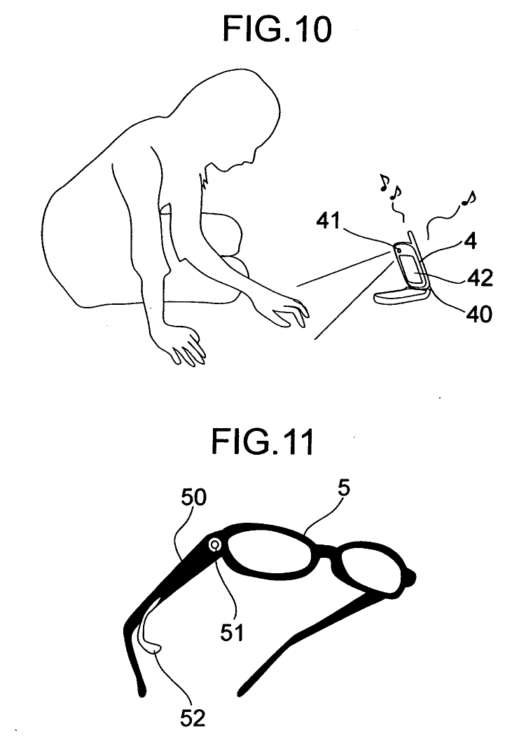

FIG. 10 is a drawing illustrating a mobile telephone device having a music generation function according to a second embodiment of the present invention.

As shown in FIG. 10, a mobile telephone device 4 having a music generation function according to the second embodiment of the present invention is provided with a miniature camera 41 similar to the one in the first embodiment, a semiconductor device (not shown) having a music generation function inside an equipment body 40 as in the first embodiment, a display device 42, and a speaker (not shown) as a music outputting device.

Also in the above mobile telephone device 4, music data are automatically generated from image data inputted by the miniature camera 41 and outputted by the speaker. In other words, without preparing music information in advance as in conventional devices, movement of an object in front of the miniature camera 41 automatically generates music corresponding to the movement of the object, and the music is played in various kinds of musical instruments. Since the mobile telephone device 4 can be easily carried, by carrying the mobile telephone device 4 and imaging an object with the miniature camera 41, music data corresponding to the movement can be automatically generated, outputted and enjoyed at any place.

In addition, as the mobile telephone device 4 has a communication function, the plurality of the mobile telephone devices 4 having the similar music generation function are disposed at a plurality of distant places and connected through networks to each other so that the generated music data can be exchanged between the devices to produce a simultaneous music performance at the plurality of places.

### Embodiment 3

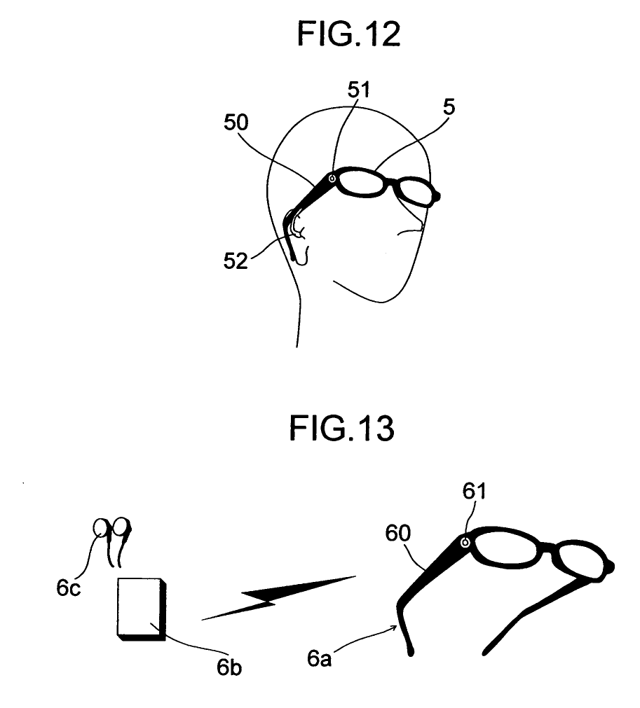

FIG. 11 is a drawing illustrating a spectacle instrument having a music generation function according to a third embodiment of the present invention; and FIG. 12 is a drawing illustrating the spectacle instrument in FIG. 11 when being worn.

As shown in FIG. 11, a spectacle instrument 5 having a music generation function according to a third embodiment of the present invention is provided with a miniature camera 51 similar to the one in the first embodiment which is fixed on a frame 50, a semiconductor device (not shown) having a music generation function as in the first embodiment housed in the frame 50, and an earphone 52 fixed on the frame 50. As shown in FIG. 12, the earphone 52 is fixed at an exact place where the earphone 52 is disposed on the ears of the wearer when the spectacle instrument 5 is worn.

Also in the above spectacle instrument 5, music data is automatically generated from image data inputted by the miniature camera 51 and outputted by the earphone 52. Namely, without preparing music information in advance as in conventional devices, movement of an object in front of the miniature camera 51 automatically generates music corresponding to the movement of the object, and the music is played in sounds of various kinds of musical instruments. Since the spectacle instrument 5 is constantly worn by a wearer, by wearing the mobile spectacle instrument 5 and imaging an object with the miniature camera 51, music data corresponding to the movement of the object can be automatically generated, outputted and enjoyed any place.

### Embodiment 4

FIG. 13 is a drawing illustrating a spectacle instrument set having a music generation function according to a fourth embodiment of the present invention.

As shown in FIG. 13, the spectacle instrument set having a music generation function according to the fourth embodiment of the present invention comprises a spectacle instrument body 6a in which a miniature camera 61 is fixed on a frame 60 as in the third embodiment, a control box 6b housing therein a semiconductor device (not shown) having a music generation function similar to the first embodiment, and an earphone 6c connected to the control box 6b. The miniature camera 61 of the spectacle instrument body 6a has a function of transmission to the semiconductor device in the control box 6b by either wireless or wire communication.

Also in the above spectacle instrument set, music data are automatically generated from image data inputted by the miniature camera 61 and outputted by the earphone 6c. The earphone 6c and the control box 6b are provided as separate bodies independent from the spectacle instrument body 6a, which makes the spectacle instrument body 6a light in weight and does not interfere with easy and comfortable wearing. Furthermore, when music is not generated, the spectacle instrument body 6a alone can be used as a simple spectacle instrument.

### INDUSTRIAL APPLICABILITY

The semiconductor device having a music generation function according to the present invention is useful as a device for adding a music generation function which automatically generates music data corresponding to image data by installing the device in a small item such as a mobile electronic device, a mobile telephone device, a spectacle instrument and a spectacle instrument set.

1. A semiconductor device having a music generation function comprising:
movement section identification means for identifying, from image data of an object continuously imaged and inputted as image data for each frame, each position where the object has moved within the frame by comparing the image data in a plurality of the frames, and
music generation means for generating music data corresponding to the position identified by the movement section identification means.

2. The semiconductor device having a music generation function according to claim 1, wherein said music generation means generates the music data from a sound source of a music instrument which corresponds to the position identified by the movement section identification means.

3. The semiconductor device having a music generation function according to claim 1, wherein said music generation means generates music data by a scale which corresponds to the position identified by the movement section identification means.

4-6. (canceled)

7. A mobile electronic device comprising:
the semiconductor device having a music generation function according to claim 1, and
imaging means for inputting the image data.

8-12. (canceled)

13. The mobile electronic device according to claim 7 further comprising means for outputting the music data generated by the music generation means.

14. The mobile electronic device according to claim 7 further comprising:
image processing means for processing the image data inputted by the imaging means corresponding to the position identified by the movement section identification means, and
display means for displaying the image data processed by the image processing means.

15-16. (canceled)

17. A mobile telephone device comprising:
the semiconductor device having a music generation function according to claim 1,
imaging means for inputting the image data, and
means for outputting the music data generated by the music generation means.

18-22. (canceled)

23. A spectacle instrument comprising:
the semiconductor device having a music generation function according to claim 1,
imaging means for inputting the image data, and
means for outputting the music data generated by the music generation means.

24. A spectacle instrument set comprising:
the semiconductor device having a music generation function according to claim 1,
a music output device for outputting the music data generated by the music generation means, and
a spectacle instrument having imaging means for inputting the image data and means for transmitting the image data inputted by the imaging means to the semiconductor device.

25. A spectacle instrument set comprising:
the semiconductor device having a music generation function according to claim 3,
a music output device for outputting the music data generated by the music generation means, and
a spectacle instrument having imaging means for inputting the image data and means for transmitting the image data inputted by the imaging means to the semiconductor device.

26-27. (canceled)
